(19) United States
(12) Patent Application Publication
(10) Pub. No.: US 2022/0260743 A1
(43) Pub. Date: Aug. 18, 2022

(54) UNDERGROUND PIPE DETECTION SYSTEM

(71) Applicant: CDCI, FAVERNEY (FR)

(72) Inventor: Pierre-Jean LAURENT, FAVERNEY (FR)

(21) Appl. No.: 17/592,523

(22) Filed: Feb. 4, 2022

(30) Foreign Application Priority Data
Feb. 15, 2021 (FR) 2101416

(51) Int. Cl. G01V 3/02

(52) U.S. Cl. CPC G01V 3/02

(57) ABSTRACT

The present invention relates to a detection system designed to allow the detection of an underground pipe, the system comprising:
a flexible element comprising a downstream free end capable of being inserted into the underground pipe through an upstream opening, the upstream free end remaining outside the underground pipe,
a detection device provided to be positioned above the underground pipe so as to detect the position of the underground pipe by detecting the presence of a section of the flexible element,
   characterized in that the flexible element is constituted by a current supplied electrical wire whose downstream free end is provided with a drive element, the drive element having a drive surface allowing a fluid to drive the drive element with the downstream free end of the wire downstream into the underground pipe.

### CROSS-REFERENCE TO RELATED APPLICATIONS

The present application claims priority to French Application No. 2101416 filed with the Intellectual Property Office of France on Feb. 15, 2021, which is incorporated herein by reference in its entirety for all purposes.

### TECHNICAL FIELD OF THE INVENTION

The present invention relates to systems for detecting underground networks.

The invention relates more particularly to a system for detecting an underground pipe by means of a flexible element that is inserted into the underground pipe.

### TECHNICAL BACKGROUND

It is known to use a semi-rigid detectable rod system that is inserted into an opening in the underground pipe and then manually pushed in, for example by U.S. Pat. No. 6,380,743B1.

This solution can sometimes be difficult to implement when the underground pipe describes a complicated circuit that prevents the rod from being pushed along the entire length of the underground pipe. In addition, the free downstream end of the rod can easily be blocked by roughness inside the underground pipe.

The evolution of the rod inside the pipe is limited by its friction against the pipe. When the elasticity of the rod does not allow any more the thrust, the detection is stopped, which occurs on average at 200 m for example.

This requires manholes or close accesses to allow detection of pipes over long distances. Sometimes accesses must be created mechanically to allow for proper detection.

### SUMMARY OF THE INVENTION

To address the aforementioned technical problems, the invention provides a detection system adapted to enable detection of an underground pipe, the system comprising:
a flexible element comprising a downstream free end able to be inserted into the underground pipe through an upstream opening, the upstream free end remaining outside the underground pipe,
a detection device adapted to be positioned above the underground pipe so as to detect the position of the underground pipe by detecting the presence of a section of the flexible element,

characterized in that the flexible element is constituted by an electrically powered wire whose downstream free end is provided with a drive element, the drive element having a drive surface allowing a fluid to drive the drive element with the downstream free end of the wire downstream into the underground pipe.

The system according to the invention is particularly economical and easy to implement. It can use either the natural flow of the fluid circulating in the underground pipe, or the flow of a fluid added to the pipe, for example air by means of an air blower of the leaf blower type.

The system according to the invention is not limited in distance. It allows for long detection lengths by a single access, for example over 1000 m. It is therefore not necessary to have accesses or manholes close together.

According to other advantageous features of the invention:
the electric wire is a twisted wire with at least two strands;
the drive element has a tubular main body;
the main body forms a float capable of remaining on the surface of a liquid flow;
the drive element has a bell-shaped wall with the top facing downstream;
the system comprises a reel on which the electric wire is intended to be wound up before being unwound;
the system comprises an air blower provided to push the drive element downstream in the underground pipe, especially when no flow is present in the pipe, for example in a wastewater pipe.

The invention also proposes a method for detecting an underground pipe characterized in that it comprises the following steps:

a) inserting a flexible element detectable by a detection device into the underground pipe through an upstream opening, the flexible element being constituted by an electric wire, a downstream free end of which is provided with a drive element having a drive surface and the upstream free end of which is provided to be supplied with electric current outside the underground pipe,

b) driving the flexible member downstream of the pipe by means of a fluid that cooperates with the drive surface of the drive member,

c) supply the electrical wire with power,

d) place the detection device above the underground pipe, above the ground, in such a manner as to detect the position of the underground pipe by detecting the presence of current flowing in the electrical wire.

Advantageously, step b) is carried out by means of an air blower.

### BRIEF DESCRIPTION OF THE FIGURES

Further features and advantages of the invention will become apparent from the following detailed description, for the understanding of which reference is made to the attached drawings in which:

FIG. 1 is a cross-sectional view schematically depicting a first embodiment of the detection system according to the invention using a pulsed air stream to push a drive element;

FIG. 2 is a view similar to FIG. 1, which represents a second embodiment of the detection system according to the invention in which the drive element has a bell-shaped main body;

FIG. 3 is a view similar to that of FIG. 1 which represents a third embodiment of the detection system according to the invention using a liquid to drive the drive element;

### DETAILED DESCRIPTION OF THE INVENTION

In the following description, identical, similar or analogous elements will be referred to by the same reference numbers.

### First Embodiment

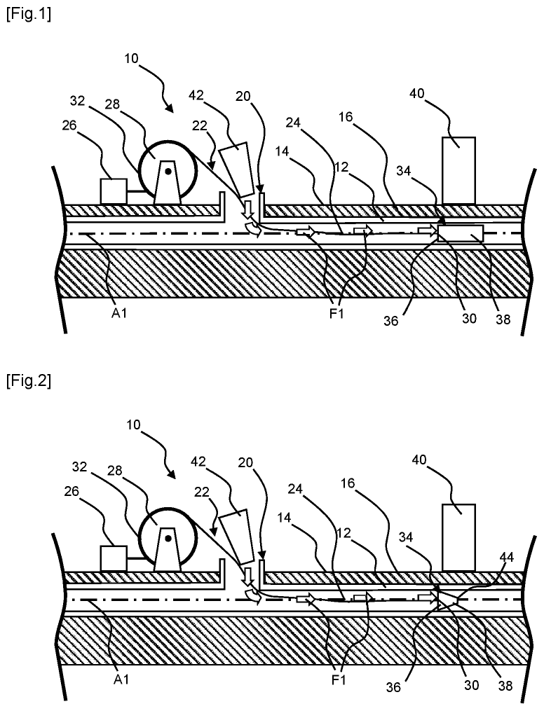

FIG. 1 shows a first embodiment of a detection system 10 designed to detect an underground pipe 12.

In the example shown, the underground pipe 12 here extends longitudinally along a main axis A1 that extends from upstream to downstream, which corresponds to an orientation from left to right when considering FIG. 1. The underground pipe 12 is, for example, a cylindrical pipe that extends below the surface of the ground 14, under a surface layer 16 of soil or other material, such as concrete.

The underground pipe 12 has a manhole 18 which forms an upstream opening 20 for insertion of a flexible element 22 belonging to the detection system 10.

In accordance with the teachings of the invention, the flexible element 22 is constituted by an electrical wire 24 supplied with electrical current by a power source 26. The electrical wire 24 is preferably of the twisted wire type, for example consisting here of two twisted strands.

The detection system 10 includes a reel 28 on which the electrical wire 24 is wound to form a coil. The electrical wire 24 has a downstream free end 30, which is intended to be inserted into the underground pipe 12 through the upstream opening 20, and an upstream free end 32 which is electrically connected to the power source 26.

In accordance with the teachings of the invention, the downstream free end 30 of the electrical wire 24 is provided with a drive member 34. The drive member 34 has a drive surface 36 for allowing a fluid to drive the drive member 34, together with the downstream free end 30 of the electrical wire 24, downstream into the underground pipe 12.

According to the first embodiment shown here, the drive element 34 includes a cylindrical tubular main body 38 to which the downstream free end 30 of the electrical wire 24 is attached by suitable means. The main body 38 has an outside diameter and radial thickness sufficient to plug a large portion of the underground pipe 12 and thus be more easily pushed by a fluid injected into the underground pipe, in particular by a pulsed air flow F1. The radial thickness of the main body 38 is, for example, between one-third and one-half of the radius of the main body 38 or the radius of the underground pipe 12. The drive element 34 is preferably made of a material light enough to be easily driven, together with the electric wire 24, by the pulsed air flow F1. The main body 38 is for example made of expanded foam.

The detection system 10 also includes a detection device 40 adapted to be positioned above the underground pipe 12, above the ground surface 14, so as to detect the position of the underground pipe 12 by detecting the presence of a section of the electrical wire 24. More particularly, the detection device 40 is arranged to detect by any suitable means the electric current flowing through the section of electric wire 24 arranged opposite.

According to the first embodiment, the detection system 10 includes an air blower 42 such as a leaf blower for injecting forced air through the upstream opening 20 to push the drive element 34 downstream. The forced air flow F1 produced by the air blower 42 pushes on the drive surface 36 causing the drive element 34 to move downstream in the underground pipe 12.

A method for detecting the underground pipe 12 implemented by means of the detection system 10 according to the first embodiment of the invention is now described.

An operator positions the reel 28 near the upstream opening 20 and inserts the drive member 34, which is attached to the downstream free end of the electrical wire 24, into the underground pipe 12 through the upstream opening 20.

The operator then produces a forced air flow F1 through the air blower 42 into the underground pipe 12 through the upstream opening 20 toward the drive member 34 so as to push the drive member 34 downstream driving the electrical wire 24 unwinding from the reel 28.

When the electrical wire 24 is sufficiently extended and the drive member 34 is sufficiently far into the underground pipe 12, the operator supplies power to the electrical wire 24 from the power source 26 and then positions the detection device 40 over the underground pipe 12, first in the vicinity of the upstream opening 20 and then along the path of the underground pipe 12, by detecting the electrical current flowing in the electrical wire 24.

### Second Embodiment

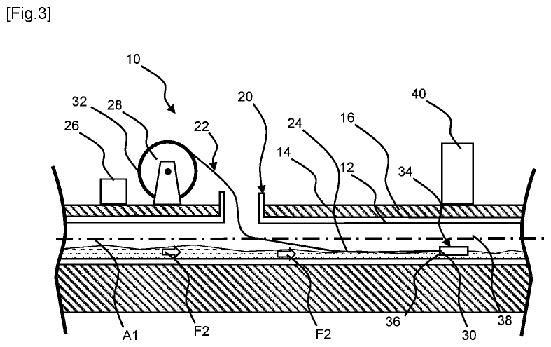

In FIG. 2, a second embodiment of the invention is shown. Only what differentiates the second embodiment from the first embodiment is now described.

The second embodiment differs from the first embodiment in the shape of the drive element 34. Indeed, the drive element 34 comprises here a main body 38 in the shape of a bell, or hat, the top 44 of which is oriented downstream. This allows the forced air flow F1 to exert a strong push on the drive element 34 by resting on the entire drive surface 36 formed here by the inner wall of the bell-shaped main body 38.

The detection method according to the invention is applied in the same way as for the first embodiment.

### Third Embodiment

In FIG. 3 a third embodiment of the invention is shown. Only what differentiates the third embodiment from the first embodiment is now described.

The third embodiment differs from the first embodiment in that a fluid other than air is used to push the drive element 34. It is a liquid flow F2 that flows downstream in the underground pipe 12 and pushes the drive element 34.

The liquid flow F2 may be that of an effluent that typically flows through the underground pipe 12. Alternatively or additionally, the operator may inject a liquid flow F2, such as water, through the upstream opening 20 to enhance the thrust force on the drive element 34.

Here, the main body 38 of the drive element 34 forms a float adapted to remain on the surface of the liquid flow F2. The drive element 34 described with the first embodiment can be employed also in the third embodiment.

Note that the underground pipe 12 may here have an internal diameter much larger than the external diameter of the drive element 34, since the drive is by flotation.

### LEGEND

10: detection system
12: underground pipe
14: ground surface
16: surface layer
18: manhole
20: upstream opening
22: flexible element
24: electric wire
26: power source
28: reel
30: downstream free end
32: upstream free end
34: drive element
36: drive surface
38: main body
40: detection device
42: air blower
44: top
A1: main axis
F1: pulsed air flow
F2: liquid flow

1. A detection system designed to allow the detection of an underground pipe, the system comprising:
a flexible element comprising a downstream free end capable of being inserted into the underground pipe through an upstream opening, the upstream free end remaining outside the underground pipe,
a detection device designed to be positioned above the underground pipe in such a way as to detect the position of the underground pipe by detecting the presence of a section of the flexible element
characterized in that the flexible element is constituted by a current-supplied electrical wire whose downstream free end is provided with a drive element, the drive element having a drive surface allowing a fluid to drive the drive element with the downstream free end of the wire downstream into the underground pipe.

2. A detection system according to claim 1, characterized in that the electrical wire is constituted by a twisted wire with at least two strands.

3. A detection system according to claim 2, characterized in that the drive element comprises a tubular main body.

4. A detection system according to claim 3, characterized in that the main body forms a float able to remain on the surface of a liquid flow.

5. A detection system according to claim 1, characterized in that the drive element has a bell-shaped wall with the apex facing downstream.

6. A detection system according to claim 1, characterized in that it comprises a reel on which the electric wire is provided to be wound before being unwound.

7. A detection system according to claim 1, characterized in that it comprises an air blower provided to push the drive element downstream into the underground pipe.

8. A method for detecting an underground pipe characterized in that it comprises the following steps:
a) inserting a flexible element detectable by a detection device into the underground pipe through an upstream opening, the flexible element being constituted by an electric wire, a downstream free end of which is provided with a drive element comprising a drive surface and the upstream free end of which is designed to be supplied with electric current outside the underground pipe
b) driving the flexible element downstream of the pipe by means of a fluid which cooperates with the drive surface of the drive element,
c) supplying current to the electrical wire,
d) placing the detection device above the underground pipe, above the ground, so as to detect the position of the underground pipe by detecting the presence of the current flowing in the electrical wire.

9. A method according to the claim 8, characterized in that step b) is carried out by means of an air blower.
